(19) United States
(12) Patent Application Publication
(10) Pub. No.: US 2005/0155449 A1
(43) Pub. Date: Jul. 21, 2005

(54) Steering wheel damper

(76) Inventors: Greg Birchmeier, White Lake, MI (US); David Palm JR., Glendale, AZ (US)

Correspondence Address: Sally J Brown;AUTOLIV ASP, INC, 3350 Airport Road, Ogden, UT, 84405, US

(21) Appl. No.: 10/761,568

(22) Filed: Jan. 21, 2004

(51) Int. Cl. G05G 1/10

(52) U.S. Cl. 74/552

(57) ABSTRACT

A steering wheel having a central member and an outer rim connected to the central member is disclosed. The central member is attachable to a steering column of a vehicle. The outer rim has one or more internal chambers. A fluid, such as antifreeze, is disposed within the internal chamber or chambers. The volume, viscosity, and weight of the fluid is selected to dampen vibrations of the steering wheel caused by operation of the vehicle and/or to achieve a desired inertia level in the steering wheel.

### BACKGROUND OF THE INVENTION

1. Field of the Invention

The present invention relates to steering wheel systems for motor vehicles. More specifically, the invention relates to the addition of fluid to the interior of a steering wheel to dampen vibration and increase the inertia of the steering wheel.

2. Description of Related Art

Motor vehicles involve components which rotate, oscillate, and move in various directions. The movement of these components produces vibrations, which can be transferred throughout the vehicle. The engine, for example, can be a source of significant vehicle vibrations. The vibrations of the engine may be minimized by altering the RPMs (revolutions per minute) of the engine. Unfortunately, these alterations may adversely affect fuel economy or the performance of the vehicle.

An additional source of vehicle vibration is contact between the vehicle and the driving surface. A number of variables affect the vibrations generated by contact with the driving surface. For example, vehicle speed, aberrations in the driving surface, wheel alignment, and uneven tire wear can significantly impact the vibrations generated in the vehicle. To address this problem, a number of shock absorbing and damping systems have been developed to enhance the suspension systems of vehicles. Nevertheless, problems still persist and vibration control is an ongoing concern for automobile manufacturers.

Certain parts of the vehicle dampen vibrations, while others transfer or increase the amplitude and frequency of the vibrations. When the frequency of the generated vibrations substantially matches the natural resonance frequency of a part of the vehicle, that part vibrates and may cause adjoining or abutting parts to also vibrate. Because the vehicle may have parts with different natural resonance frequencies, vibration may occur and be transmitted to parts of the vehicle not only when the vehicle is traveling at a high rate of speed, but also in other circumstances, such as when the vehicle is idling. Such vibrations can cause annoyance to the driver and even premature part failure.

To minimize or avoid vibrations, parts of the vehicle have been designed to have a natural resonance frequency outside the range of vibration frequencies encountered during normal operation of the vehicle. This may be accomplished by increasing the mass or by changing the tensile strength or elasticity of the part. However, these alterations may be expensive and can adversely affect the performance of the vehicle.

One part of the motor vehicle where these issues are important is the steering wheel. The feel of the steering wheel in the hands of a driver influences driver performance and comfort. It has been shown that even a slight vibration in the steering wheel can cause driver fatigue and discomfort.

Steering wheel vibrations can also affect a driver's decision to purchase a vehicle. These vibrations may cause a potential purchaser to believe that the vehicle is not operating properly, or that the vehicle is of inferior quality.

In an attempt to minimize steering wheel vibration, many different systems have been used. For example, a weight may be secured to the steering wheel using a bracket. The weight may be made of lead or cast iron. Rubber or another pliable material is sandwiched between the weight and the bracket. Unfortunately, these damping systems often require additional space and significant design alterations to the steering wheel. Moreover, they are often inconsistent with the aesthetic or functional scheme of the vehicle.

In addition, elastic or rubber components may be used in the steering assembly to absorb vibrations. Unfortunately, these components have a limited damping effect, and can require significant and costly modifications to the steering assembly.

Many complex dynamic and static systems have also been designed in an attempt to minimize steering wheel vibration. One such system involves a rotor attached to a pinion in a rack-and-pinion steering system in a vehicle. The rotor is disposed in a Newtonian fluid that provides resistance to the rotational velocity of the rotor and pinion and thereby dampens vibrations in the steering column. In one embodiment, the fluid is magneto-rheological, or responds to the influence of a magnetic field, such that a magnetic field may be applied to the fluid to vary the damping effect of the system.

These complex damping systems are, unfortunately, expensive and require extensive modifications of the vehicle for installation. Moreover, they often involve a complex set of interconnected moving parts, which are subject to wear and tear and increase the likelihood of product failure.

Accordingly, there is a need in the art for a novel damping system that addresses one or more of the above-listed problems. Such a device is disclosed herein.

### SUMMARY OF THE INVENTION

The present invention has been developed in response to the present state of the art, and, in particular, in response to problems and needs in the art that have not yet been fully solved by currently available steering wheel dampers. More specifically, the present invention provides a cost-effective system for damping vibrations in the steering wheel of a vehicle by placing a damping fluid in the outer rim of the steering wheel. The present invention also provides a convenient technique for adjusting the weight and thus the inertia of the steering wheel, which facilitates smooth operation of the vehicle.

The steering wheel of the present invention includes a central member, an outer rim having one or more internal chambers, and a fluid disposed within the internal chamber or chambers. The central member of the steering wheel is attachable to a steering column. The central member can include various components, such as a driver's side airbag module, a horn, and cruise control buttons.

The outer rim is connected to the central member by at least one spoke. The outer rim generally encircles the central member. Thus, the outer rim is positioned proximate the peripheral edges of the central member, although it should be noted that the outer rim does not necessarily extend entirely around the central member. In one embodiment, the outer rim is a radial extension of the central member. The outer rim may be made from various materials, including metal, polymers, wood, fiberglass, or composite materials.

The outer rim is shaped to receive the driver's hands during operation of a vehicle. Accordingly, the rim may be embodied in various shapes, such as a circular, elliptical, or polygonal shape.

The outer rim includes one or more internal chambers, which contain the fluid. The internal chamber or chambers are closed such that the fluid is retained within the chamber or chambers. In one embodiment, the internal chamber is continuous such that the fluid may flow in both a clockwise and a counterclockwise direction from each point within the internal chamber. The outer rim may also include a plurality of discrete internal chambers that are not in fluid communication with each other.

The fluid may be embodied as a liquid, gel, or other semi-solid. The fluid may comprise a single substance or a combination of substances. For example, the fluid may comprise emulsions, colloids, liquid polymers, or gels. Representative examples of suitable fluids include, but are not limited to, water, oil, grease, and antifreeze.

The volume, viscosity, and weight of the fluid are selected to dampen vibrations of the outer rim and/or provide a predetermined inertia for the outer rim. In certain embodiments, the volume of the fluid is less than the entire volume of the internal chamber. For example, the volume of the fluid may be about half of the entire volume of the internal chamber.

The viscosity of the fluid may range between, for example, about 0.001 poise (for water and water-based solutions) to about 6.6 poise (for materials having a molasses like viscosity). Fluids of other viscosities may also be used to achieve the objectives noted above.

As will be understood by those of skill in the art, the selected volume, viscosity, and weight of the fluid within the internal chamber depends on the vibrational characteristics of the vehicle. Factors that influence the vibrational characteristics of the vehicle include the dimensions of the vehicle, materials from which the vehicle is constructed, range of RPMs of the engine of the vehicle, and whether other damping devices are present within the vehicle. Those skilled in the art will recognize that the vibrational characteristics of a particular vehicle may be determined experimentally by conducting tests on the vehicle or may be estimated based on the characteristics of the vehicle.

The fluid also influences the inertia of the outer rim. By introducing a different volume of fluid or fluid of a different type, the overall weight and thus the inertia of the steering wheel is altered. A steering wheel that is too heavy creates too much inertia and makes it difficult to rotate the steering wheel from a resting position or to stop the steering wheel once it has begun to rotate in a particular direction. In contrast, a steering wheel that is too light makes it difficult to smoothly operate the vehicle.

The viscosity of the fluid also affects the inertia of the steering wheel. A fluid that is too viscous may make it difficult to change the direction of the steering wheel, while a fluid of insufficient viscosity will not provide adequate resistance to rotation of the wheel to enable smooth operation of the vehicle. Accordingly, the fluid within the outer rim may be selected to provide a predetermined inertia for the outer rim. Through altering the volume and type of the fluid within the steering wheel, the present invention provides a simple, cost-effective technique for changing the inertia of the steering wheel.

In one embodiment, the fluid remains in a liquid state throughout the normal range of operating temperatures of the steering wheel. Thus, the fluid may have a freezing point below the range of operating temperatures of the steering wheel and/or a boiling point above this range. In one embodiment, the fluid remains in a liquid state between minus 40° Fahrenheit and plus 194° Fahrenheit.

In certain embodiments, particles or solid masses are combined with the fluid to form a mixture. Adding particles or solid masses may alter the weight, and viscosity of the fluid. As a consequence, the fluid has different inertial and damping properties. For example, by adding the particles, the natural frequency of the steering wheel may be altered.

The outer rim may have a hole to permit insertion of fluid into the internal chamber. Following insertion of the fluid, the hole is sealed, for example, with a plug. In one embodiment, the plug may be removable to permit alteration of the volume and type of fluid within the outer rim when, for example, the vibrational characteristics of the vehicle change as the vehicle ages.

In view of the foregoing, the steering wheel of the present invention provides substantial advantages over conventional damping systems. The present invention is easy to implement and is cost-effective. Furthermore, the volume and type of fluid in the outer rim may be easily adjusted to adapt to the vibrational characteristics of a particular vehicle. Furthermore, the inertia of the steering wheel may be set to a desired level by adjusting the volume and type a fluid present in the outer rim. The present invention is also compact and takes advantage of a space in the vehicle that was previously unused.

These and other features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and features of the invention are obtained, a more particular description of the invention summarized above will be rendered by reference to the appended drawings. Understanding that these drawings illustrate only selected embodiments of the invention and are not therefore to be considered limiting in scope, the invention will be described and explained with additional specificity and detail through the use of the accompanying drawings in which:

FIG. 1 is a perspective view of the interior of a driver's side of a vehicle which includes one embodiment of a steering wheel;

FIG. 2 is a cross-sectional view of a steering wheel according to one embodiment of the present invention;

FIG. 3 is a radial cross-sectional view of the outer rim and fluid taken across line 3-3 of FIG. 2;

FIG. 4 is a perspective view of a steering wheel according to one embodiment of the present invention; and

FIG. 5 is a perspective rear view of a steering wheel according to one embodiment of the present invention.

### DETAILED DESCRIPTION OF THE PREFERRED EMBODIMENTS

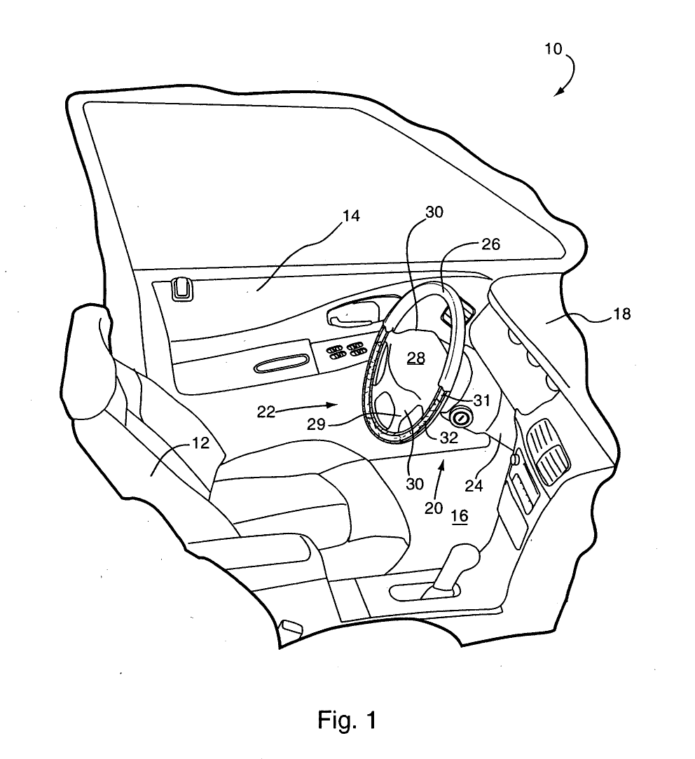

The preferred embodiments of the invention are now described with reference to FIGS. 1-5, wherein like parts are designated by like numerals throughout. The members of the present invention, as generally described and illustrated in the Figures, may be constructed in a wide variety of configurations. Thus, the following more detailed description of the embodiments of the present invention, as represented in the Figures, is not intended to limit the scope of the invention, as claimed, but is merely representative of presently preferred embodiments of the invention.

In this application, the phrases “connected to,” “coupled to,” and “in communication with” refer to any form of interaction between two or more entities, including mechanical, electrical, magnetic, electromagnetic, electromechanical and thermal interaction. The phrase “attached to” refers to a form of mechanical coupling that restricts relative translation or rotation between the attached objects. The phrases “pivotally attached to” and “slidably attached to” refer to forms of mechanical coupling that permit relative rotation or relative translation, respectively, while restricting other relative motion.

The phrase “directly attached to” refers to a form of attachment by which the attached items are either in direct contact, or are only separated by a single connector, adhesive, or other attachment mechanism. The term “abutting” refers to items that are in direct physical contact with each other, although the items may not be attached together.

With reference to FIG. 1, there is illustrated a perspective view of the interior of the driver's side of a vehicle 10. The depicted vehicle 10 includes conventional interior components, such as a seat 12, side door 14, floor board 16, and dashboard 18. A steering assembly 20 is positioned generally in front of the seat 12.

The steering assembly 20 includes a steering wheel 22 coupled to a steering column 24. The steering column 24 is, in turn, coupled to the wheels (not shown) of the vehicle 10 such that rotation of the steering wheel 22 results in redirection of the wheels of the vehicle 10. The steering column 24 may also include, for example, shafts, gears, knobs, or buttons (not shown) which allow the driver to control other components of the vehicle 10, such as the turn signals and windshield wipers (not shown).

The steering wheel 22 comprises an outer rim 26 and a central member 28. The central member 28 connects the steering wheel 22 to the steering column 24. The central member 28 may include various instruments and components. For example, a horn, driver's side airbag, stereo controls, and cruise control buttons may be integrated into the central member 28.

The central member 28 is also connected to the outer rim 26. As shown, one or more spokes 29 connect the central member 28 to the outer rim 26. Alternatively, the central member 28 may radially extend and engage the outer rim 26. In another embodiment, the central member 28 may be integrated with the outer rim 26.

The outer rim 26 generally encircles the central member 28. Thus, the outer rim 26 is positioned proximate peripheral edges 30 of the central member 28, although it should be noted that the outer rim 26 does not necessarily extend entirely around the central member 28.

The outer rim 26 may be embodied in a number of different shapes. For example, the outer rim 26 may be circular or toroidal in shape, as shown. Alternatively, the outer rim 26 may have a generally elliptical or polygonal shape.

The outer rim 26 can be made from dense, heavy materials. Positioning a relatively significant amount of weight around the central member 28 increases the inertia of the steering wheel 22 and prevents inadvertent rotation of the wheel 22 during operation of the vehicle 10. Therefore, the outer rim 26 may be made from dense materials, such as steel or cast iron.

The outer rim 26 includes an internal chamber 31. In one embodiment, the internal chamber 31 may extend around a part or extend entirely around the central member 28. In an alternative embodiment, the outer rim 26 may include a plurality of discrete internal chambers 31 that are not in fluid communication with each other.

As indicated above, a fluid 32 is disposed within the internal chamber 31. In FIG. 1, a portion of the outer rim 26 is cutaway to show the fluid 32 disposed within the internal chamber 31. The internal chamber 31 is closed such that the fluid 32 is retained within the internal chamber 31.

The fluid 32 may be embodied as a liquid, gel, or other semi-solid. The fluid 32 may also comprise a single substance or a combination of substances. For example, the fluid may comprise emulsions, colloids, liquid polymers, or gels. Representative examples of suitable fluids 32 include, but are not limited to, water, oil, grease, and antifreeze.

The volume, viscosity, and weight of the fluid 32 are selected to dampen vibrations of the outer rim 26 and/or provide a predetermined inertia for the outer rim 26. In certain embodiments, the fluid 32 occupies less than the entire volume of the internal chamber 31. For example, the fluid 32 may occupy about half of the entire volume of the internal chamber 31.

The viscosity of the fluid 32 may range between, for example, about 0.001 poise (for water and water-based solutions) to about 6.6 poise (for materials having a molasses like viscosity). Fluids 32 of other viscosities may also be used to achieve the objectives noted above.

As will be understood by those of skill in the art, the selected volume, viscosity, and weight of the fluid 32 within the internal chamber 31 depend on the vibrational characteristics of the vehicle 10. Factors that influence the vibrational characteristics of the vehicle 10 include the dimensions of the vehicle 10, materials from which the vehicle 10 is constructed, range of RPMs of the engine (not shown) of the vehicle 10, and whether other damping devices are present within the vehicle 10. Those skilled in the art will recognize that the vibrational characteristics of a particular vehicle 10 may be determined experimentally by conducting tests on the vehicle 10 or may be estimated based on the characteristics of the vehicle 10.

As stated above, the fluid 32 also influences the inertia of the outer rim 26. By introducing a different volume of fluid 32 or fluid 32 of a different type, the overall weight and thus the inertia of the steering wheel 22 is altered. A steering wheel 22 that is too heavy creates too much inertia and makes it difficult to rotate the steering wheel 22 from a resting position or to stop the steering wheel 22 once it has begun to rotate in a particular direction. In contrast, a steering wheel 22 that is too light makes it difficult to smoothly operate the vehicle 10.

The viscosity of the fluid 32 also affects the inertia of the steering wheel 22. A fluid 32 that is too viscous may make it difficult to change the direction of the steering wheel 22, while a fluid 32 of insufficient viscosity will not provide adequate resistance to rotation of the wheel 22 to enable smooth operation of the vehicle 10. Accordingly, the fluid 32 within the outer rim 26 may be selected to provide a predetermined inertia for the outer rim 26. Through altering the volume and type of fluid 32 within the steering wheel 22, the present invention provides a simple, cost-effective technique for changing the overall inertia of the steering wheel 22.

In one embodiment, the fluid 32 remains in a liquid state throughout the normal range of operating temperatures of the steering wheel 22. Thus, the fluid 32 may have a freezing point below the normal range of operating temperatures of the steering wheel 22 and/or a boiling point above this range. In one embodiment, the fluid 32 remains in a liquid state between minus 40° Fahrenheit and plus 194° Fahrenheit.

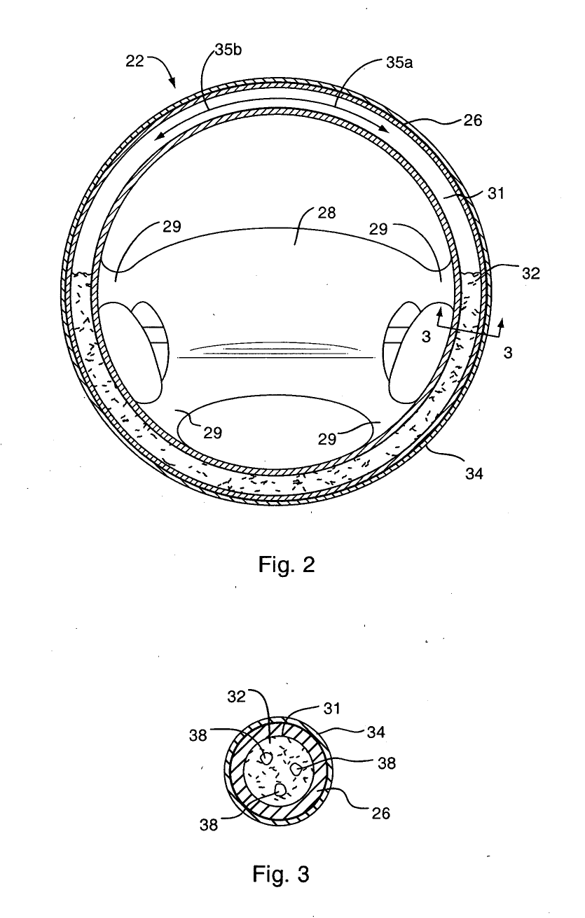

Referring now to FIG. 2, a cross-sectional view of a steering wheel 22 according to one embodiment of the present invention is illustrated. As shown, the fluid 32 is disposed within the internal chamber 31 in the outer rim 26. The fluid 32 occupies about half the volume of the internal chamber 31. Spokes 29 connect the central member to the outer rim 26.

In this embodiment, the steering wheel 22 includes a skin 34. The skin 34 may be a coating of rubber, plastic, or the like which covers the outer rim 26. The skin 34 may also cover the central member 28.

In one embodiment, there is no fluid communication between the internal chamber 31 and the central member 28 or the spokes 29 of the central member 28. In the illustrated embodiment, the internal chamber 31 is continuous such that the fluid 32 may flow in both a clockwise and a counterclockwise direction 35a, 35b from each point within the internal chamber 31.

FIG. 3 illustrates a radial cross-section taken along line 3-3 of FIG. 2. In particular, FIG. 3 depicts a cross-sectional view of the skin 34 and outer rim 26. The internal chamber 31 having the fluid 32 with particles 38 disposed therein is also shown.

As illustrated, the radial shape of the internal chamber 31 and outer rim 26 is circular. As will be understood by those of skill in the art, the internal chamber 31 or outer rim 26 may have other radial shapes, such as an elliptical or polygonal shape. Also, the radial shape of the internal chamber 31 and outer rim 26 are not necessarily the same. For example, the outer rim 26 may have a circular radial shape, while the internal chamber 31 may have a square radial shape. In addition, the radial shape of the internal chamber 31 and outer rim 26 may be uniform or different at different positions around the steering wheel 22.

In certain embodiments, particles 38 are combined with the fluid 32 to form a mixture. Adding particles 38 may change the weight, volume, and viscosity of the fluid 32. As a result, the fluid 32 has different inertial and damping properties. For example, by adding the particles 38, the natural frequency of the steering wheel 22 may be altered.

The quantity and size of particles 38 depends on the desired weight of the fluid 32 and the volume available within the internal chamber 31. The particles 38 may be shaped, for example, as spheres, shavings, or strands. The particles 38 may be of uniform or divergent shapes and sizes. The particles 38 may be made from a variety of materials, such as lead, iron, steel, plastics, polymers, or natural materials such as wood. The particles 38 may be more or less dense than the fluid 32. In one embodiment, the particles 38 are suspended in the fluid 32.

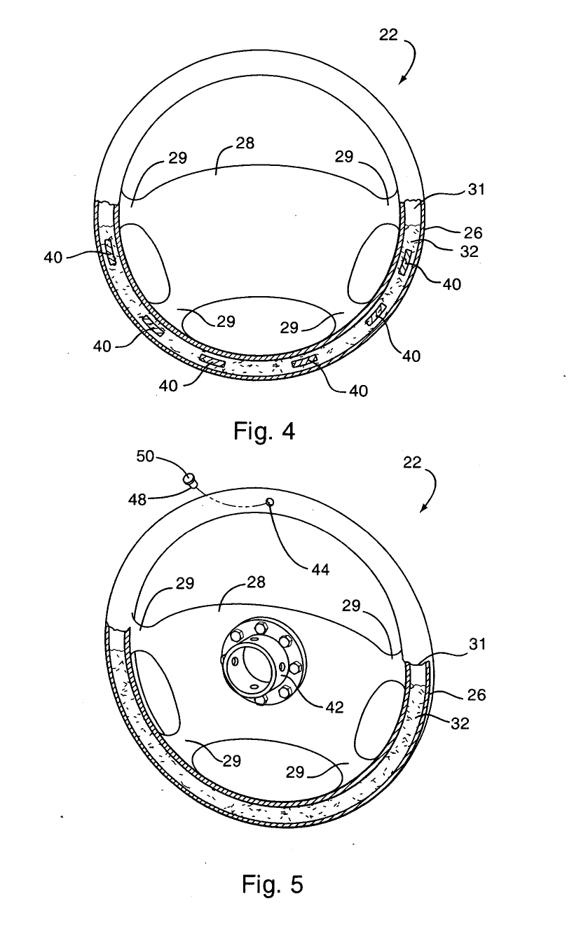

FIG. 4 illustrates a perspective view of another embodiment of the steering wheel 22. A portion of the outer rim 26 is cutaway to show the fluid 32 disposed within the internal chamber 31 of the outer rim 26. Spokes 29 connect the central member to the outer rim 26.

In this embodiment, the fluid 32 includes one or more solid masses 40. Each solid mass 40 is larger than each particle 38 shown in FIG. 3. The solid mass or masses 40 may be made from materials similar to those described above in relation to the particles 38. The solid masses 40 may be of divergent or uniform shapes and sizes. For example, the solid masses 40 may be rectangular or cylindrical in shape, as shown in FIG. 4. In an alternative embodiment (not shown), the solid mass 40 is ring-shaped and is sized to be positioned throughout the internal chamber 31 and suspended in the fluid 32. Of course, the fluid 32 may include particles 38 and one or more solid masses 40.

The solid masses 40 may be more or less dense than the fluid 32. As mentioned earlier, the altered weight, volume, and/or viscosity of the fluid 32 changes the rotational inertia of the steering wheel 22 and the damping properties thereof.

Referring now to FIG. 5, a rear view of one embodiment of the steering wheel 22 is illustrated. Again, a portion of the outer rim 26 is cutaway to show the fluid 32 disposed within the internal chamber 31. This rear view illustrates an attachment mechanism 42 for securing the steering wheel 22 to the steering column 24 (shown in FIG. 1). In FIG. 5, the steering wheel 22 is shown without the protective skin 34 (illustrated in FIG. 2). Those skilled in the art will recognize that various techniques and mechanisms may be used for securing the steering wheel 22 to the steering column 24 within the scope of this invention.

In the illustrated embodiment, a hole 44 is provided in the outer rim 26 to add to or remove fluid 32 from the internal chamber 31. The hole 44 may be positioned on the backside of the outer rim 26. In certain embodiments that include a solid mass 40 and/or particles 38, the hole 44 is large enough such that solid masses 40 and particles 38 may pass through the hole 44. Alternatively, the solid masses 40 and/or particles 38 may be inserted into the internal chamber 31 prior to closing or sealing the chamber 31.

The hole 44 may be sealed using a number of different techniques, which are known to those of skill in the art. For example, the hole 44 may be sealed using a plug 46 having a stem 48 and a head 50, as illustrated in FIG. 5. The plug 46 is sized to be seated in the hole 44. In an alternative embodiment, the plug 46 may be embodied as a sphere (not shown) that can be secured within the hole 44 using, for example, heat or pressure welding, adhesives, soldering, or brazing.

In one embodiment, the plug 46 is removable. Thus, the hole 44 may be opened to alter the volume or type of fluid 32 in the internal chamber 31. Adjusting the volume and type of fluid 32 in the outer rim 26 allows the steering wheel 22 to be fine tuned to better dampen vibrations or to change the inertia of the steering wheel 22, as desired.

Accordingly, in an embodiment with a removable plug 46, a base amount of fluid 132 may be added to the steering wheel 22 during manufacture. The steering wheel 22 may then be shipped to an assembly plant. Thereafter, the amount of fluid 32 may be adjusted according to the inertia and vibration requirements of the vehicle 10 in which it is installed.

In addition, as a vehicle 10 ages, the vibrational characteristics of the vehicle 10 may change. Using the removable plug 46, the volume and type of fluid 32 may be altered to adapt to the new vibrational characteristics of the vehicle 10. Thus, the removable plug 46 permits alteration of the type and volume of fluid 32 at various stages of the life of the vehicle 10.

In summary, the steering wheel of the present invention provides substantial advantages over conventional damping systems. The present invention is easy to implement and is cost-effective. Furthermore, the volume and type of fluid in the outer rim may be easily adjusted to adapt to the vibrational characteristics of a particular vehicle. Furthermore, the inertia of the steering wheel may be set to a desired level by adjusting the volume and type of fluid present in the outer rim. The present invention is also compact and takes advantage of a space in the vehicle that was previously unused.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A steering wheel for a vehicle, comprising:
a central member attachable to a steering column;
an outer rim connected to the central member and having an internal chamber, wherein the outer rim generally encircles the central member; and
a fluid disposed within the internal chamber, wherein the fluid dampens vibration during steering wheel use.

2. The steering wheel of claim 1, wherein the internal chamber is continuous such that the fluid may flow in both a clockwise and a counterclockwise direction from each point within the internal chamber.

3. The steering wheel of claim 1, wherein the fluid has a volume selected to dampen vibrations of the outer rim caused by operation of a connected vehicle.

4. The steering wheel of claim 1, wherein the fluid occupies less than an entire volume of the internal chamber,

5. The steering wheel of claim 4, wherein the fluid occupies less than three quarters of the entire volume of the internal chamber.

6. The steering wheel of claim 1, wherein the fluid has a viscosity selected to dampen vibrations of the outer rim caused by operation of a connected vehicle.

7. The steering wheel of claim 1, wherein the fluid has a weight selected to dampen vibrations of the outer rim caused by operation of a connected vehicle.

8. The steering wheel of claim 1, further comprising particles disposed within the fluid.

9. The steering wheel of claim 1, further comprising at least one solid mass disposed within the fluid.

10. The steering wheel of claim 1, wherein the fluid is selected from a group consisting of water, oil, grease, antifreeze, and a combination thereof.

11. The steering wheel of claim 1, wherein the fluid has a volume, viscosity, and weight selected to provide a predetermined inertia for the outer rim.

12. The steering wheel of claim 1, wherein the fluid remains in a liquid state between approximately minus 40° Fahrenheit and approximately plus 194° Fahrenheit.

13. The steering wheel of claim 1, wherein the outer rim comprises a sealable hole for inserting the fluid into the internal chamber.

14. The steering wheel of claim 13, further comprising a removable plug sized to be seated in the hole.

15. A steering wheel, comprising:
a central member attachable to a steering column;
an outer rim connected to the central member and having an internal chamber, wherein the outer rim generally encircles the central member; and
a fluid disposed within the internal chamber, wherein the fluid dampens vibration during steering wheel use, wherein the fluid occupies less than an entire volume of the internal chamber, and wherein the internal chamber is continuous such that the fluid may flow in both a clockwise and a counterclockwise direction from each point within the internal chamber.

16. The steering wheel of claim 15, wherein the outer rim is generally circular.

17. The steering wheel of claim 15, wherein the fluid occupies less than three quarters of the entire volume of the internal chamber.

18. The steering wheel of claim 15, further comprising particles disposed within the fluid.

19. The steering wheel of claim 15, further comprising at least one solid mass disposed within the fluid.

20. The steering wheel of claim 15, wherein the outer rim comprises a sealable hole for inserting fluid into the internal chamber.

21. The steering wheel of claim 20, further comprising a removable plug sized to be seated in the hole.

22. The steering wheel of claim 15, wherein the internal chamber is disposed entirely within the outer rim.

23. The steering wheel of claim 15, wherein the fluid is selected from a group consisting of water, oil, grease, antifreeze, and a combination thereof.

24. The steering wheel of claim 15, wherein the fluid has a volume, viscosity, and weight selected to dampen vibrations of the outer rim caused by operation of a connected vehicle.

25. The steering wheel of claim 15, wherein the fluid has a volume, viscosity, and weight selected to provide a predetermined inertia for the outer rim.

26. A steering wheel for a vehicle, comprising:
a central member attachable to a steering column of a vehicle;
a generally circular outer rim connected to the central member and having an internal chamber; and
a fluid disposed within the internal chamber, wherein the fluid occupies less than an entire volume of the internal chamber, and wherein the fluid has a volume, viscosity, and weight selected to dampen vibrations of the outer rim caused by operation of the vehicle.

27. The steering wheel of claim 26, wherein the fluid occupies less than three quarters of the entire volume of the internal chamber.

28. The steering wheel of claim 26, further comprising particles disposed within the fluid.

29. The steering wheel of claim 26, further comprising at least one solid mass disposed within the fluid.

30. The steering wheel of claim 26, wherein the outer rim comprises a sealable hole for inserting fluid into the internal chamber.

31. The steering wheel of claim 26, wherein the fluid is selected from a group consisting of water, oil, grease, antifreeze, and a combination thereof.

32. A steering wheel for a vehicle, comprising:
central member means for attachment to a steering column of a vehicle;
outer rim means for connection to the central member means, the outer rim means having an internal chamber, wherein the outer rim means generally encircles the central member means;
a damping means disposed within the internal chamber for damping vibrations of the outer rim caused by operation of the vehicle, wherein the damping means comprises a fluid that occupies less than an entire volume of the internal chamber.
